(19) United States
(12) Patent Application Publication
(10) Pub. No.: US 2013/0117150 A1
(43) Pub. Date: May 9, 2013

(54) METHOD FOR FACILITATING GIFT GIVING

(71) Applicant: CLOVER BY CLOVER, LLC, Burlingame, CA (US)

(72) Inventors: Erin Aliaga, Hillsborough, CA (US); Elizabeth Ellis Chung, Hillsborough, CA (US)

(73) Assignee: CLOVER BY CLOVER, LLC, Burlingame, CA (US)

(21) Appl. No.: 13/668,140

(22) Filed: Nov. 2, 2012

Related U.S. Application Data
(60) Provisional application No. 61/556,199, filed on Nov. 5, 2011.

(51) Int. Cl. G06Q 30/06

(52) U.S. Cl. 705/26.8

(57) ABSTRACT

Disclosed herein is a method for facilitating gift giving. A personalized page based on a first set of inputs received from a first user is created. A preselected gift selected by a gift recipient is displayed or described the personalized page, which may be viewed on a device. Then, a gift giver is invited to contribute. A monetary amount is divided into a first portion and a second portion based on a second input from a second user or gift giver. The first portion of the monetary amount is assigned to the preselected gift and the second portion of the monetary amount is assigned for a monetary donation to charity. No specific money amounts are prominently displayed on the personalized page.

### CROSS REFERENCE TO RELATED APPLICATIONS

This application claims priority benefit to U.S. Provisional Application No. 61/556,199, entitled “Gift Giving Method” filed Nov. 5, 2011, which is incorporated by reference in its entirety herein as if it was put forth in full below.

### BACKGROUND

Traditional gift giving is inefficient. Each year in the United States, billions of dollars are wasted on gifts that people do not want or need. In addition, large sums of money are spent on extravagant, disposable gift bags, wrapping and bows. Eventually, most of these items end up in a landfill contributing to problems such as loss of space and pollution.

A gift registry facilitates communication between a recipient and a gift giver for special occasions, for example, weddings, baby showers, birthdays, graduations and holidays. It is a public, wish list comprising items a recipient desires. Gift givers make a purchase discretely and can be certain that the purchased item is something that the receiver wants and will appreciate. The registry is managed by removing desired items once purchased. When managed efficiently, a registry can prevent gift givers from duplicating gifts.

Traditionally, a gift registry is specific to one particular retailer so that when the recipient registers for physical gifts, they are limited to the stock of the given retailer. In one currently available gift registry, a third party maintains the registry and the recipient may register for physical gifts from any retailer.

Another type of gift registry is a monetary registry where the recipient requests gift givers to contribute a monetary amount. The recipient registers for various monetary values which may look like a physical gift such as a coffee maker, television, dishes or the like, or an activity or experience such as dinner at a fancy restaurant, scuba diving excursion, tickets to a theatre play or the like, or a charitable donation. A gift recipient may also register for both a gift and a monetary donation. Typically, a third party maintains the list for the recipient for a fee then distributes the collected monies to the recipient. The recipient is then free to spend the money at their discretion.

Some third parties providing gift registries allow a gift recipient to create a page on a website with information about the gift recipient's event, like birthday party details. It is known in the art to take a received monetary gift and divide it between a gift recipient and a predetermined charity. Some third parties providing gift registries partner with retailers such that the retailer agrees to donate a percentage of the gift purchase price to a charity.

### SUMMARY

Disclosed herein is a method for facilitating gift giving. A personalized page based on a first set of inputs received from a first user is created. A preselected gift selected by a gift recipient is displayed or described the personalized page, which may be viewed on a device. Then, a gift giver is invited to contribute. A monetary amount is divided into a first portion and a second portion based on a second input from a second user or gift giver. The first portion of the monetary amount is assigned to the preselected gift and the second portion of the monetary amount is assigned for a monetary donation to charity. No specific money amounts are prominently displayed on the personalized page.

The present invention is better understood upon consideration of the detailed description below in conjunction with the accompanying drawings and claims.

### BRIEF DESCRIPTION OF DRAWINGS

FIG. 1 illustrates an example environment for a method for facilitating gift giving;

FIG. 2 provides an example flowchart of an embodiment for a method for facilitating gift giving;

FIG. 3 depicts an example flowchart for the gift giver for a method for facilitating gift giving; and

FIG. 4 shows an example flowchart for disbursement of funds for a method for facilitating gift giving.

### DETAILED DESCRIPTION

The present invention provides a method for facilitating gift giving that enables group giving and gift sharing, making celebrations meaningful, convenient and environmentally conscious. In one embodiment, a personalized page based on a first set of inputs received from a first user is created. A preselected gift selected by a gift recipient is displayed or described on the personalized page, which is available for viewing on a device. Then, a gift giver is invited to contribute. A monetary amount is received from the gift giver and divided into a first portion and a second portion based on a second input from a second user or gift giver. The first portion of the monetary amount is for the preselected gift and the second portion of the monetary amount is for a monetary donation to charity. No specific money amounts are prominently displayed on the personalized page.

The method may optionally allow collecting the first portion of the monetary amount and the second portion of the monetary amount. The preselected gift may be a physical gift or a gift card. In one embodiment, the preselected gift is purchased using the first portion of the monetary amount and the preselected gift is sent the gift recipient. The charity may be chosen by the gift recipient or from a list on a website or by other means. The monetary donation may be sent to the charity. In one embodiment, any excess of the first portion of the monetary amount which is greater than a total price of the preselected gift is sent to the charity. In another embodiment, any excess of the first portion of the monetary amount which is greater than a total price of the preselected gift is sent to the gift recipient.

The personalized page is provided on a website. The first user may be the gift recipient. In one embodiment, the main focus of the personalized page is the preselected gift and the charity and not on a monetary value. In another embodiment, other media associated with the personalized page has no prominent display of the specific money amounts.

In one embodiment, the first user may customize the personalized page. In another embodiment, displayed on the personalized page is a description of the charity, a logo of the charity, and a link to a website of the charity. In yet another embodiment, social network feedback or social network messages are displayed on the personalized page.

The method allows an account page for the first user and/or gift giver where specific monetary amounts are displayed. These money amounts are associated with the gifts given and/or donations made. In a further embodiment, the method also coordinates with a third party to facilitate the management of the first portion of the monetary amount and of the second portion of the monetary amount by the third party.

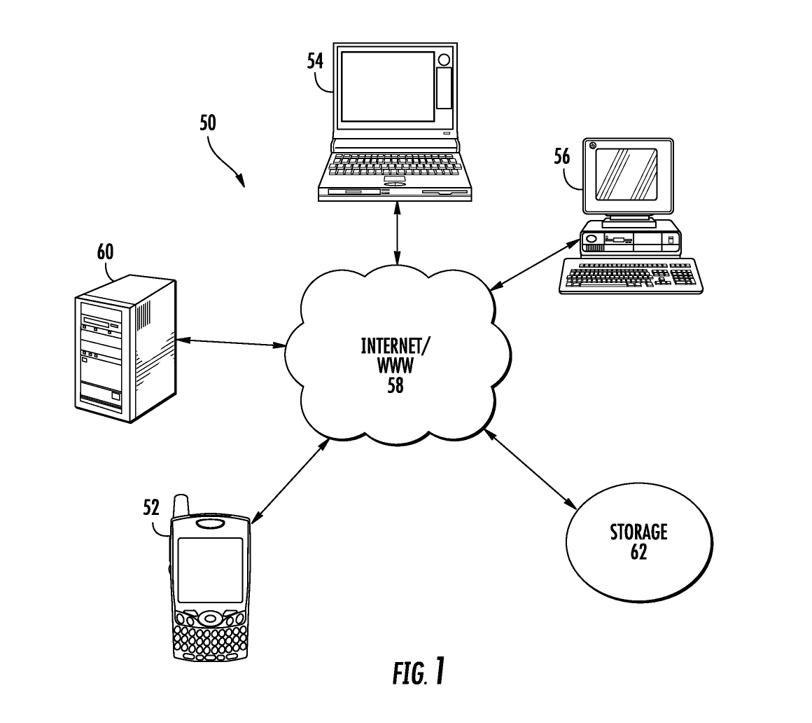

FIG. 1 illustrates an example environment for a method of facilitating gift giving 50. A first or second user utilizes a device to access a website containing a page displaying or describing a gift giving method. The device may be a phone 52, PDA, laptop 54, personal computer 56 or the like. This device 52/54/56 connects to a server 60 through the Internet or the World Wide Web (aka Web and www) 58, using a proprietary protocol for communication and connects to a website. Server 60 may create temporary or permanent files in storage 62 which may be located in the same physical location of server 60, or it may be located remotely or physically away from server 60 as shown in FIG. 1. Once on the website, the first or second user may navigate to the applicable website personalized page and/or create a new personalized page for displaying a desired, preselected gift.

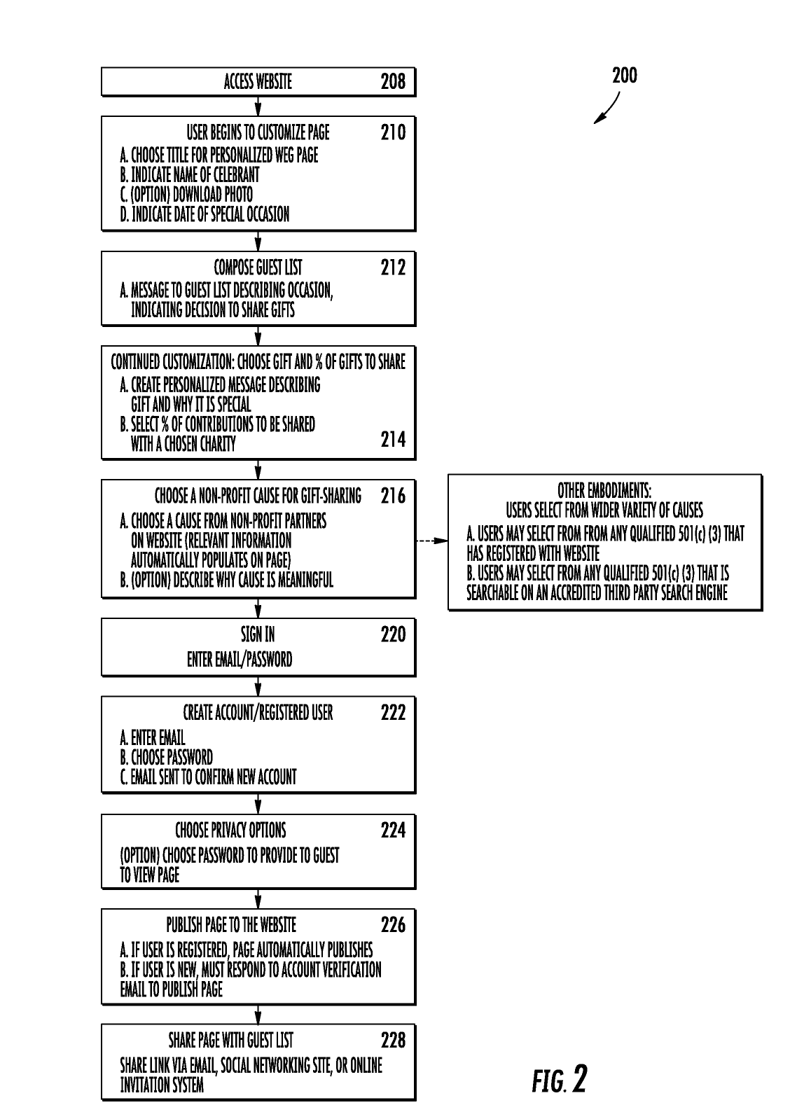

FIG. 2 provides an example flowchart of an embodiment for a method for facilitating gift giving 200 in which a first user accesses a website and begins the process of creating a personalized page for members of a guest list to view based on a first set of inputs received from a first user. Alternatively, the personalized page may be available to everyone and not limited to a guest list. In this example, the personalized page is provided on a website. This personalized page may be public or only accessible to the first user and those invited to give. Therefore, the personalized page is visible to the first user as well as others. In this embodiment, this personalized page is personalized and communicates details about one special gift the gift recipient really wants as well as information about a non-profit organization the gift recipient has chosen to share a percentage of gift proceeds with. In this way, guests are invited to make a monetary gift to the gift recipient, which will then be divided into a first portion for the desired gift displayed on the personalized page and a second portion for the charitable cause. This method is utilized instead of bringing a physical gift to the event. The main focus of the personalized page is the preselected gift and the charity and not on a monetary value.

The percentage of monetary amount for the preselected gift vs. the charity may be determined by the gift recipient. For example, the gift recipient may want 20% of the monetary amount to be for the preselected gift and 80% for the charity donation. Likewise, the gift recipient may want 50% of the monetary amount to be for the preselected gift and 50% for the charity donation. Optionally, the gift recipient may want 0% of the monetary amount to be for the preselected gift and 100% for the charity donation.

Once connected to the website at step 208, the process starts at step 210. The first user, which may be the gift recipient (or a parent, friend or assistant for the gift recipient or the like), creates a personalized page by inputting a title, name of the gift recipient (also known as the celebrant) and type, date and location of the event. In this way, the first user customizes the personalized page. Optionally, photos may be uploaded to the personalized page.

To aid the first user through the process, a software wizard tool or setup assistant may be used. This wizard tool is a user interface type that presents a first user with a sequence of dialog boxes and leads the first user through a series of well-defined steps. In other embodiments, the first user may be guided through by drop-down menus or by an expert system which guides a first user through a series of yes/no questions. Other commercially available techniques may be used to walk the first user through the options.

At step 212, the first user creates a guest list comprising of friends, relatives, neighbors and anyone else to share the occasion with. A message is created by the first user describing the occasion and indicating their decision to share gifts with a charitable cause, and is sent to the members of the guest list.

The personalized page is further customized by the first user at step 214. The first user (in some cases the gift recipient) decides on one gift such as a physical gift or gift card which is known as the preselected gift. A preselected gift selected by a gift recipient is displayed or described on a device and on the personalized page. Optionally, a photo of the preselected gift is displayed on the personalized page. In one embodiment, the first user provides a description of why this gift is desired and/or special. The first user then decides what percentage of monetary gifts received will be divided into a first portion and a second portion. The first portion of the monetary amount is used to buy the preselected gift while the second portion of the monetary amount is for a monetary donation to the selected charity.

The charity may be chosen by the gift recipient or from a list on a website. In one embodiment, at step 216, the first user chooses a non-profit cause from a non-profit partner listed on the website in which to share the second portion of the monetary amount. The first user may add to the personalized page a description of the charity, a logo of the charity, and a link to a website of the charity. In one embodiment, these items automatically populate the personalized page when the charity is selected. Optionally, the first user may add a description and information on the personal significance of the charity. In another embodiment, first users may select a charity from any qualified 501(c)(3) organization that has registered with the website. In a further embodiment, first users may select from any qualified 501(c)(3) organization that is searchable on an accredited third party search engine. The system may optionally, automatically generate a receipt to gift givers after the gifts are made.

At step 220, the first user is requested to sign in by entering an email address and creating a password. This creates an account and an account page and establishes a registered user at step 222. A verification email is sent to the entered email address to confirm the new account. In another embodiment, an account does not have to be created establishing a registered user.

Next, privacy options are designated at step 224. The first user may optionally choose a password to provide to guests in order to view the personalized page. At step 226, if the user is registered, the personalized page is automatically published to the website and is available to be viewed. If the user is new, the new user may be required to respond to the account verification email before the personalized page will publish. A confirmation email is then sent to the entered email address confirming the successful personalized page creation.

The personalized page may now be viewed by guests. At step 228, the first user may share the personalized page and password, if applicable, with guests by providing a link to the personalized page on the website. This may be accomplished by using tools such as email, social networking sites such as Facebook/MySpace, Twitter, online invitation system, other Apps, a custom domain name or the like. Guests may also search for the personalized page/event on the website by using the gift recipient's name. In other embodiments, guests may search by event or date.

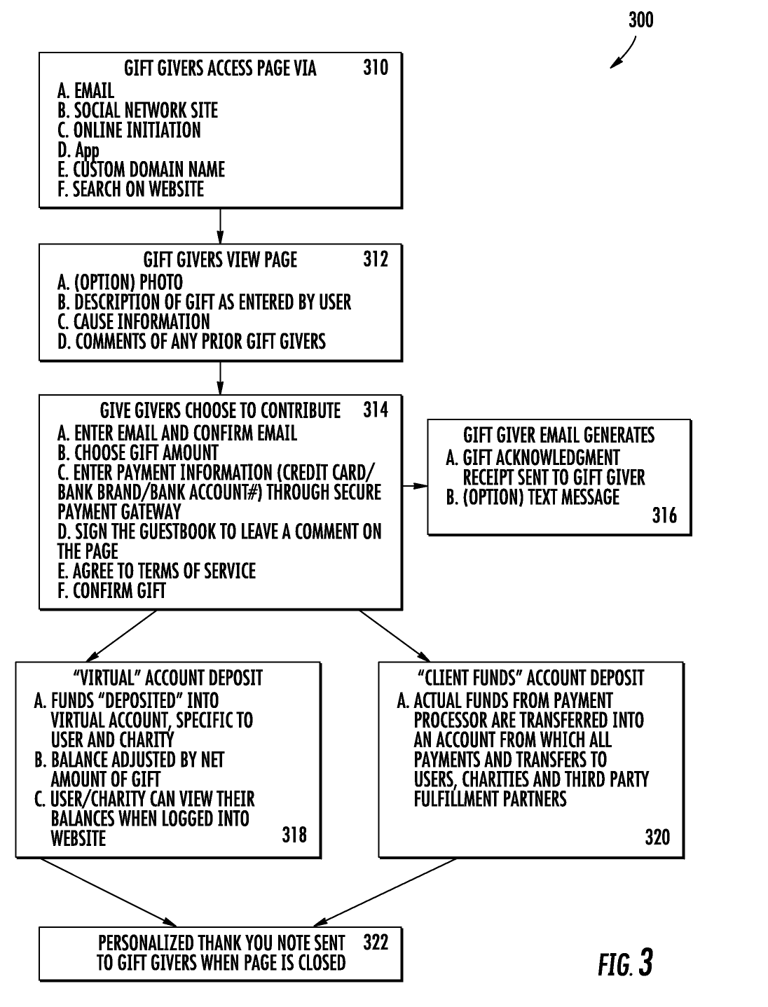

FIG. 3 depicts an example flowchart of an embodiment for a method for facilitating gift giving 300 in which a guest, known as a gift giver, accesses the gift recipient's personalized page on the website. The process starts at step 310 where the gift giver accesses the gift recipient's personalized page via any method described above. At step 312, the gift giver views the gift recipient's personalized page learning all the information disclosed including the one special gift (or perhaps multiple desirable gifts) the gift recipient really wants as well as the gift recipient's desire to share a percentage of the gifts with a charitable cause.

A gift giver is invited to contribute. At step 314, the gift giver (or a second user acting on the gift giver's behalf) may choose to contribute. This is done by entering and confirming an email address then choosing a monetary gift amount to contribute. This amount may be any value the gift giver is comfortable with. No specific money amounts are prominently displayed on the personalized page and the gift amount chosen is kept private meaning not known to anyone other than the giver and the recipient. In an alternative embodiment, no specific money amounts are displayed anywhere in the personalized page. Next, this method allows collecting the first portion of the monetary amount and the second portion of the monetary amount. The gift giver enters payment information through a secure payment gateway using a credit card, bank transfer, online money transfer or the like. The gift giver then has the opportunity to sign the guestbook. The guestbook provides a means for comments, opinions, social feedback and messages to be posted publically on the personalized page. In one embodiment, social network feedback or social network messages are displayed on the personalized page. Other methods for on-line social interaction are also possible.

Returning to step 312, all information in the guestbook may be viewed by all gift givers. In another embodiment, the guestbook is private and can only be viewed by the gift recipient. Further, the gift giver agrees to Terms of Service and finally, confirms the monetary gift amount. The gift giver also has the opportunity to create a greeting card for the gift recipient which may be downloaded, personalized and sent by email or printed out for hand delivery. At step 316, a gift acknowledgment receipt is sent via email to the gift giver. Optionally, a text message may be sent in addition to or in lieu of the email message.

In one embodiment, the account page is private and managed by the first user who originally set up the account or personalized page. The information cannot be accessed without a password. Therefore, second users, including gift givers, do not have access to someone else's account page. In this way, second users, or other users, or gift givers, cannot view gifts from others given to the gift recipient. Thus, the monetary amount associated with a gift given and/or donation made is private and secret, so it is only known to the specific gift giver and the first user who set up the personalized page. In another embodiment, charities have an account page that is also private and can only be accessed with a password by someone acting on behalf of the charity.

The monetary gift from the gift giver is deposited into “virtual” accounts at step 318. This may be done manually or in an automated way using software. The accounts are specific to the gift recipient and the various charities. The monetary gift from the gift giver may be subject to a fee collected by the website. In another embodiment, advertising is used to pay for the website services. The balance is deposited into the appropriate specific “virtual” account based on the percentage the first user established at step 214. First users and charities may view their balances by logging into the website and accessing the account page. Step 320 defines “client funds” which is the actual balance in the specific accounts available for distribution after the money has actually cleared from processing. For instance, if a gift giver used a bank transfer method for payment, the funds may take up to three business days until they are truly available. Funds cannot be transferred out of this account for any purpose other than to disburse funds to gift recipients, charities or third party fulfillment partners.

While the personalized page is available to guests, the first user or gift recipient may check the status of gifts received and read comments in the guestbook. Once the gift recipient celebrates the special occasion and feels that all monetary gifts have been presented, the personalized page may be closed. The funds collected may be disbursed before, during or after the closing of the personalized page. When the first user closes the personalized page by selecting the proper option, an email is sent to the first user's email account confirming the closure of the personalized page.

At step 322, a personalized thank you note to the gift giver from the gift recipient and the charity is generated and sent to the gift giver when the personalized page is closed. The thank you note is created by the gift recipient (or first user from FIG. 2) and may be personalized, for example, with a special thank you message in text, photos, videos and/or music thanking the gift giver for making their gift wish come true and also for helping others in need.

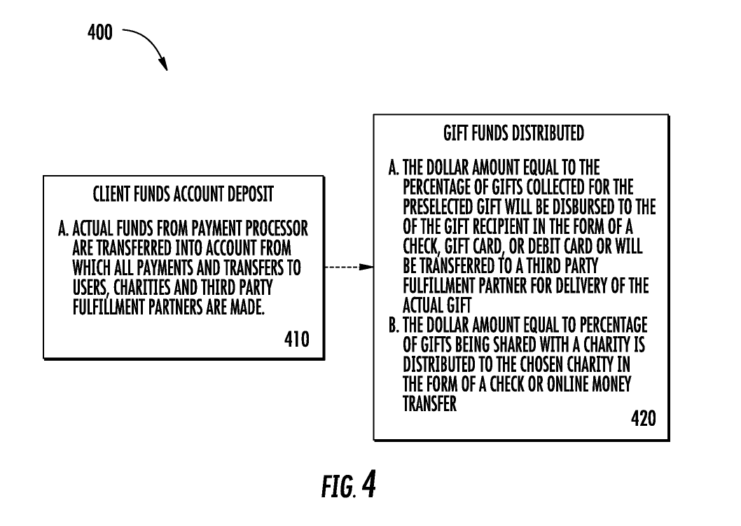

In one embodiment, at the end of the event and once the personalized page is closed, the total monetary gifts collected (net after handling fees) are distributed. FIG. 4 shows an example flowchart for disbursement of funds according to a method for facilitating gift giving 400. At step 410, client funds account deposit are the funds from the payment processor that are transferred into the account from which all payments and transfers are made to first users, charities and third party fulfillment partners. At step 420, the gift funds are distributed. The dollar amount equal to the percentage of gifts collected for the preselected gift will be disbursed to the gift recipient in the form of a check, gift card, or debit card or will be transferred to a third party fulfillment partner for delivery of the actual gift. Furthermore, the dollar amount equal to the percentage of gifts being shared with a charity is distributed to the chosen charity in the form of a check or online money transfer.

The preselected gift is purchased using the first portion of the monetary amount and the preselected gift is sent the gift recipient. In this embodiment, the dollar amount collected for the preselected gift will be disbursed to the gift recipient in the form of a check, gift card, debit card or as the actual gift. The monetary donation is sent to the charity using the second portion of the monetary amount. The percentage of gifts being shared with a charity is distributed to the chosen charity in the form of a check or online money transfer. If the value of the total monetary gifts collected is less than the actual price of the preselected gift, the gift recipient can apply additional funds to still purchase the preselected gift, or the gift recipient may select a less expensive gift or the first user may opt to receive a gift card in lieu of the preselected gift. If the value of the total monetary gifts collected is greater than the total price of the preselected gift, the gift recipient may donate the excess money to the charity. In another embodiment, if the value of the total monetary gifts collected is greater than the total price of the preselected gift, the excess money is sent to the gift recipient.

In a further embodiment, the preselected gift is fulfilled by a third party partner (e.g., Amazon.com, Target.com, Nordstroms.com or the like). For instance, if the total monetary gifts collected are, at least, equal to the cost of the item plus shipping, the item is automatically shipped from the third party after receiving the appropriate funds through the website. Any excess money is delivered to the gift recipient in the form of an online credit or gift card from the third party. If however, the total monetary gifts collected are less than cost of the preselected gift plus shipping, the first user has the choice to collect the monetary gift in the form of a an online credit or gift card from the third party. In a yet another embodiment, if the total monetary gifts collected are less than the cost of the preselected gift plus shipping, the first user has the choice to collect the monetary gift in the form or a check, gift card or debit card through the website.

If the special celebration is postponed, the first user can update the event details on the personalized page and notify the guests. If the special celebration is cancelled, the monetary gifts collected may be returned to each guest provided the personalized page is active (i.e., not closed).

In another embodiment, a third party may be used to collect funds, pay for the gift and donate to the charity. In this embodiment, a method for coordinating gift giving is provided. This method includes the step of (i) inviting a gift giver to contribute and (ii) dividing the monetary amount into a first portion for the gift and a second portion for the charity, but the method all coordinates with a third party to facilitate management of the funds by the third party.

The following examples are provided to demonstrate embodiments without limiting the scope of the present invention.

### Example 1

Peter is having a Bar Mitzvah party and has created and personalized his personalized page using the gift method of the present invention. He has chosen a scooter costing $150 as a preselected gift and Doctors Without Borders/Médecins Sans Frontières (MSF) as his charitable cause. He would like to share 50% of his gift proceeds with MSF. He is expecting 20 guests to contribute an average gift of $20. Therefore, he can expect to collect a total of $360 in gift proceeds net of handling fees. Because he chose to share 50% of his gift proceeds with MSF, his wish will be fulfilled and his charitable cause will receive $180. Peter's new scooter is delivered by a third party fulfillment partner along with a gift card for $15 ($180 received—$150 scooter—$15 shipping fee).

### Example 2

Anna is graduating high school! She creates and personalizes her personalized page for her graduation party using the gift method of the present invention. Anna would like a $600 tablet computer as her preselected gift and chooses the Wildlife Conservation Society as her charitable cause. 50 guests are expected at her party, each contributing an average gift of $20. If she chooses to share 50% of the gift proceeds net of handling fees, she will receive a check for $450 that she can use toward her tablet computer and her charity will also receive $450.

### Example 3

It's John birthday! John's mom has created and personalized a personalized page for John's birthday party using the gift method of the present invention. John would like a $75 building block toy and decides to share 75% of his gifts with Second Harvest Food Bank. He receives $400 worth of gifts (net of handling fees) through his personalized page. John's mom decides to donate the $25 excess money to Second Harvest Food Bank and receives a check for $75 to buy his special present. Second Harvest Food Bank also receives a check for an additional $300.

This method allows the gift recipient to thoughtfully and respectfully ask guests to contribute to a special gift that's really wanted, perhaps costing more than one guest would be willing to pay. Also, the method does not prominently display money amounts on the personalized page keeping the focus on the special gift and the charity instead of the money. Furthermore, other media associated with the personalized page such as social networking links or posts on Facebook/MySpace and Twitter, emails, greeting cards and thank you notes have no prominent display of the specific money amounts.

This is counter-intuitive since the gift giver is giving money. Thus, using this method helps strike a meaningful balance between giving and receiving by focusing on both a celebration for the gift recipient and also on helping others in need. For the gift giver, this process is convenient saving both time and money because the gift giver does not have to travel to a store, shop, wrap a physical gift nor purchase an accompanying greeting card. Recyclable and non-recyclable waste generated by physical gifts is reduced and the gift giver knows their gift really matters to both the gift recipient and charity.

Again, the present invention focuses on the preselected gift and the charity, not the monetary value. This is significant for many reasons. For example, many believe our culture is too focused on money and status rather than enjoying life and giving back to the community. In addition, many parents want to isolate kids from money considerations and emphasize the joy of giving. Finally, the method allows gift givers to thoughtfully give a monetary gift without pressure or consideration for other gifts already provided. This is also counterintuitive to typical gift giving methods where a predetermined amount of cash or a specifically priced item is requested by the gift recipient and publically displayed so that it is available for any user to view.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

What is claimed:

1. A method comprising the steps of:
enabling a first user to create a personalized page based on a first set of inputs received from the first user;
displaying or describing on a device a preselected gift selected by a gift recipient, the displaying or describing being on the personalized page;
inviting a gift giver to contribute;
receiving a monetary amount from the gift giver; and
dividing the monetary amount into a first portion and a second portion based on a second input from a second user or gift giver;
wherein the first portion of the monetary amount is for the preselected gift;
wherein the second portion of the monetary amount is for a monetary donation to charity; and
wherein no specific money amounts are prominently displayed on the personalized page.

2. The method of claim 1, further comprising the steps of:
collecting the first portion of the monetary amount and the second portion of the monetary amount;
purchasing the preselected gift using the first portion of the monetary amount; and
sending the gift recipient the preselected gift.

3. The method of claim 1, further comprising the step of sending the monetary donation to the charity.

4. The method of claim 2, further comprising the step of sending any excess of the first portion of the monetary amount which is greater than a total price of the preselected gift to the charity.

5. The method of claim 2, further comprising the step of sending any excess of the first portion of the monetary amount which is greater than a total price of the preselected gift to the gift recipient.

6. The method of claim 1, wherein the first user customizes the personalized page.

7. The method of claim 1, wherein the preselected gift is a physical gift or a gift card.

8. The method of claim 1, wherein the charity is chosen by the gift recipient or from a list on a website.

9. The method of claim 1, wherein specific money amounts are displayed on an account page.

10. The method of claim 1, further comprising the step of displaying on the personalized page a description of the charity, a logo of the charity, and a link to a website of the charity.

11. The method of claim 1, further comprising the step of displaying on the personalized page social network feedback or social network messages.

12. The method of claim 1, wherein a main focus of the personalized page is the preselected gift and the charity; and wherein the main focus is not on a monetary value.

13. The method of claim 1, wherein the first user is the gift recipient.

14. The method of claim 1, wherein other media associated with the personalized page has no prominent display of the specific money amounts.

15. A method, the method comprising the steps of:
enabling a first user to create a personalized page based on a first set of inputs received from the first user;
displaying or describing on a device a preselected gift selected by a gift recipient, the displaying or describing being on the personalized page;
inviting a gift giver to contribute; and
dividing a monetary amount into a first portion and a second portion based on a second input from a second user or gift giver;
wherein the first portion of the monetary amount is assigned to the preselected gift;
wherein the second portion of the monetary amount is assigned to a monetary donation to charity; and
wherein no specific money amounts are prominently displayed on the personalized page.

16. The method of claim 15, wherein specific money amounts are displayed on an account page.

17. The method of claim 15, wherein the charity is chosen by the gift recipient or from a list on a website.

18. The method of claim 15, wherein a main focus of the personalized page is the preselected gift and the charity; and wherein the main focus is not on a monetary value.

19. The method of claim 15, wherein other media associated with the personalized page has no prominent display of the specific money amounts.

20. The method of claim 15, further comprising the steps of coordinating with a third party, the third party capable of accepting payment, paying the first portion of the monetary amount, and paying the second portion of the monetary amount.
